(19) United States
(12) Patent Application Publication
(10) Pub. No.: US 2024/0083176 A1
(43) Pub. Date: Mar. 14, 2024

(54) CONSUMABLE CONTAINER, CONSUMABLE CHIP, AND INKJET PRINTER

(71) Applicant: ZHUHAI PRINT-RITE MICROELECTRONICS CORPORATION, Zhuhai (CN)

(72) Inventors: Guanguo WEN, Zhuhai (CN); Shoujie LUO, Zhuhai (CN)

(73) Assignee: ZHUHAI PRINT-RITE MICROELECTRONICS CORPORATION, Zhuhai (CN)

(21) Appl. No.: 18/515,323

(22) Filed: Nov. 21, 2023

Related U.S. Application Data
(63) Continuation-in-part of application No. PCT/CN2022/098032, filed on Jun. 10, 2022.

(30) Foreign Application Priority Data
Dec. 16, 2021 (CN) 202111544323.3

(51) Int. Cl. B41J 2/175

(52) U.S. Cl. CPC B41J 2/1753; B41J 2/1752; B41J 2/17553

(57) ABSTRACT

A consumable container, a consumable chip, and an electronic imaging device are provided, where the consumable container includes a box body, a first circuit board is disposed on a sidewall of the box body, at least one first function contact part is disposed on the first circuit board, and the first function contact part is configured to be connected to a pin on a first side of a printhead carriage pin frame. A second circuit board is further disposed on the box body, and the second circuit board and the first circuit board are separated from each other. At least one second function contact part is disposed on the second circuit board, and the second function contact part is configured to be connected to a pin on a second side of the printhead carriage pin frame and/or a contact point on a chip main control circuit board.

### CROSS-REFERENCE TO THE RELATED APPLICATIONS

This application is the continuation-in-part application of International Application No. PCT/CN2022/098032, filed on Jun. 10, 2022, which is based upon and claims priority to Chinese Patent Application No. 202111544323.3, filed on Dec. 16, 2021, the entire contents of which are incorporated herein by reference.

### TECHNICAL FIELD

The present invention relates to the field of inkjet printing technologies, and specifically, to a consumable container, a consumable chip, and an inkjet printer.

### BACKGROUND

Inkjet printers are common office equipment, providing great convenience for modern office work. Inkjet printers use ink cartridges containing ink as consumable containers to spray ink on paper to form texts or patterns to be printed on the paper.

Referring to FIG. 1, an existing color inkjet printer has a housing 11. The inkjet printer shown in FIG. 1 omits a tray of the housing 11. An inkjet printer core 12 is disposed in the housing 11, and a slide rod is disposed therein; and a printhead carriage 14 reciprocates along the slide rod as driven by a motor (not visible in FIG. 1). A chip main control circuit board (not visible in FIG. 1) is disposed in the printhead carriage 14, and the chip main control circuit board communicates with the core 12 by using a flat cable 13.

Multiple ink cartridges 15 are detachably installed on the printhead carriage 14, and different ink cartridges 15 accommodate ink of different colors. A structure of the ink cartridge 15 is shown in FIG. 2. The ink cartridge 15 has a box body 16, and the box body 16 encloses to form a cavity that accommodates ink. An ink outlet port 17 is disposed at a lower end of the cavity, and the ink in the cavity flows out through the ink outlet port 17, and is supplied to an ink supply pin of the printhead carriage 14.

A chip 18 is installed on an outer wall of the box body 16 of the ink cartridge 15, and the chip 18 has a substrate. A side of the substrate is provided with multiple connection terminals 19, which are configured to be electrically connected to a pin on the printhead carriage 14. A memory (not visible in FIG. 2) is disposed on the other side of the substrate. Generally, the memory is a non-volatile memory, such as an EEPROM or a FLASH, and stores information related to the ink cartridge, including variable information and invariant information, where the variable information is information that changes continuously with a printing operation, such as an ink level, print duration, and a printed paper quantity, and the invariant information is information that does not change with a printing operation, such as an ink cartridge type, an applicable inkjet printer type, and an ink color.

After the ink cartridge 15 is installed in the printhead carriage 14 of the inkjet printer, the inkjet printer powers on the chip 18, reads data stored in the memory of the chip 18, and determines whether the ink cartridge 15 is of a proper type and whether remaining ink quantity in the ink cartridge 15 is sufficient. The inkjet printer can not print until it is determined that the ink cartridge 15 is of a proper type and there is enough ink in the ink cartridge 15.

Referring to FIG. 3, nine connection terminals are disposed on one surface of a substrate 20 of an existing chip 18. When viewed downward from an ink cartridge chip installation direction, that is, an arrow direction in FIG. 3, multiple connection terminals are arranged in two rows, where the first row located above includes four connection terminals, which are respectively connection terminals 21, 22, 23, and 24, and the second row located below includes five connection terminals, which are respectively connection terminals 25, 26, 27, 28, and 29. These connection terminals are divided into three groups according to functions. The first group of connection terminals are two connection terminals 21 and 24 located at two ends of the first row, this group of connection terminals are detection terminals, the second group of connection terminals are two connection terminals 25 and 29 located at two ends of the second row, and this group of connection terminals are high-voltage terminals.

The third group of connection terminals are connection terminals electrically connected to a memory, and are generally located at a middle position of each row of connection terminals. For example, the connection terminals 22, 23, 26, 27, and 28 are connection terminals used to connect to the memory, where the connection terminal 26 is a power supply terminal, and the connection terminal 27 is a ground terminal.

The detection terminals 21 and 24 may have multiple functions. The first function is to detect whether all ink cartridges 15 are installed in place. If the detection terminals 21 and 24 on an ink cartridge of each color are electrically connected to corresponding pins on the inkjet printer side, it may be considered that all the ink cartridges are installed in place. The second function is to detect whether a short circuit occurs between the high-voltage terminals 25 and 29 and the terminals 21 and 24. Generally, two detection terminals 21 and 24 on a same chip 18 are electrically connected to each other, that is, the two detection terminals 21 and 24 are short-circuited.

The high-voltage terminals 25 and 29 may also have multiple functions. The first function is as follows: When a piezoelectric sensor is connected between the high-voltage terminals 25 and 29, after the high-voltage terminal 25 receives a high-voltage signal, the high-voltage signal passes through the piezoelectric sensor and is outputted from the high-voltage terminal 29. The inkjet printer determines the remaining ink quantity in the ink cartridge 15 by receiving the signal outputted by the high-voltage terminal 29. The second function is to detect whether an ink cartridge of a specific color is installed in place. When a resistor with a specific resistance value is connected between the high-voltage terminals 25 and 29, the inkjet printer applies a first high-voltage signal of a specific waveform on the terminal 25 and also applies a second high-voltage signal, on the terminal 29, that is different from the first high-voltage signal on the terminal 25, so that waveforms of the high-voltage signals on the terminals 25 and 29 are superposed. The inkjet printer determines, by detecting whether a waveform of the superposed high-voltage signal is within a predetermined range, whether the ink cartridge of the specific color is installed in place.

Referring to FIG. 4 and FIG. 5, the printhead carriage 14 has multiple printhead units. For example, one printhead unit thereof is 51, an ink cartridge 15 of each color is corresponding to one printhead unit, and structures of multiple printhead units are the same. The following uses the printhead unit 51 as an example for description. In addition, multiple pin frames 36 are further disposed in the printhead carriage 14, and multiple pins are disposed on the pin frames 36 in the printhead unit 51, for example, nine pins are included. The multiple pins are arranged in two rows, two pins at two ends of the first row above are respectively pins 41 and 44, and two pins at two ends of the second row below are respectively 45 and 49. The multiple pins of the printhead unit 51 are in a one-to-one correspondence with multiple connection terminals on the chip 18, and each pin is in contact with a corresponding connection terminal to implement electrical connection. The inkjet printer communicates with the chip 18 by using N (N≤5) of the nine pins, for example, reads data stored in the memory of the chip 18.

The multiple connection terminals on the chip 18 are divided into multiple groups, and correspondingly, the multiple pins of the printhead unit 51 are also divided into three groups. The pins 41 and 44 of the printhead unit 51 are first function pins, and the first function pins are corresponding to the detection terminals 21 and 24, and are configured to send/receive detection pulse signals outputted by the detection terminals 21 and 24. The pins 45 and 49 of the printhead unit 51 are second function pins, and the second function pins are corresponding to the high-voltage terminals 25 and 29, and may apply relatively high voltages to the high-voltage terminals 25 and 29. The remaining pins are third function pins, correspond to the third group of connection terminals of the chip 18, and are configured to communicate with the memory.

A chip main control circuit board 33 is disposed at the rear of the printhead carriage 14, and multiple contact points 34 are disposed on the chip main control circuit board 33. Multiple pins 38 are also disposed on a side of the pin frame 36 close to the chip main control circuit board 33, pins on the two sides of the pin frame 36 are in a one-to-one correspondence with each other, and two corresponding pins are electrically connected. The pin 38 close to the chip main control circuit board 33 abuts against the contact point 34 on the chip main control circuit board 33 and implements electrical connection. The chip main control circuit board 33 further includes a control chip and a detection circuit (not shown in the figure), which are configured to communicate with chips 18 on multiple ink cartridges of different colors, and perform the foregoing installation detection and short-circuit detection functions.

Generally, the inkjet printer detects installation of multiple ink cartridges 15 by using the first function pins 41 and 44 and the detection terminals 21 and 24 on the chip 18, that is, detects whether the multiple ink cartridges are all correctly installed. In addition, the inkjet printer further detects installation of a single ink cartridge 15 by using the second function pins 45 and 49 and the high-voltage terminals 25 and 29 on the chip 18, that is, detects whether an ink cartridge corresponding to one printhead unit is correctly installed.

The inkjet printer needs to output a high-voltage signal to the high-voltage terminals 25 and 29. Generally, the high-voltage signal may be up to 40 volts. If an ink drop falls between multiple connection terminals, a short circuit occurs between the multiple connection terminals. For example, the ink drop falls among the connection terminals 21, 25 and 26. Once the high-voltage terminal 25 is loaded with a relatively high voltage, a voltage on the connection terminal 26 is also relatively high. The connection terminal 26 is a connection terminal that is used to supply power to the memory, and is also referred to as a power supply terminal. An operating voltage of the memory is usually about 3.3 volts. If the connection terminal 26 is loaded with a relatively high voltage, the memory burns, which even affects operation of the inkjet printer.

Therefore, a detection circuit is disposed in a control circuit 30 of the inkjet printer, and determines, by detecting the voltages of the detection terminals 21 and 24, whether an abnormal condition occurs. For example, if an ink drop falls among the connection terminals 21, 25, and 26, when the high-voltage terminal 25 is loaded with a high-voltage signal, the voltage of the detection terminal 21 also increases. Once the inkjet printer detects that the voltage of the detection terminal 21 is too high, a high-voltage signal loaded on the high-voltage terminal 25 is disconnected, thereby preventing the high voltage of the connection terminal 26 from damaging the memory.

However, because the detection circuit 30 is disposed on the chip main control circuit board 33, only after an electrical signal of the detection terminal 21 needs to be transmitted to the chip main control circuit board 33, the inkjet printer can determine a level of the detection terminal 21, and then disconnect power supply to the high-voltage terminal 25. Generally, it usually takes several milliseconds from detecting that the level of the detection terminal 21 is too high to disconnecting the power supply to the high-voltage terminal 25, which may cause damage to the memory. In addition, once the detection terminal 21 is abnormal or the detection circuit is abnormal, and a short circuit between the high-voltage terminal 25 and the connection terminal 26 is not detected in a timely manner, storage damage is caused because the memory is loaded with an excessively high voltage for a long time. Therefore, an excessively high voltage loaded to the power supply terminal on the substrate 20 is a main cause of damage to the memory.

In addition, because the detection terminals 21 and 24 are relatively close to the high-voltage terminals 25 and 29, a problem of false detection may be easily caused. For example, a foreign matter exists between the detection terminal 21 and the high-voltage terminal 25, which causes the voltage of the detection terminal 21 to rise, but the connection terminal 26 may still not be short-circuited. However, in this case, the control circuit 30 determines that an abnormal condition occurs, and gives an abnormal alarm, which affects normal operation of the inkjet printer.

Chinese Patent Application No. CN2021110631452 discloses a connector, a chip, and an inkjet printer. The connector is disposed between a pin frame 36 and an ink cartridge 15. Although a case in which an ink drop falls on the chip, causing damage to a memory can be avoided to a great extent, when the connector is installed, a user needs to align a clamping slot on the connector with a limit piece between two printhead units on a printhead carriage 14, and the limit piece is generally relatively small and a user operation is troublesome. Chinese Patent Application No. CN202111162579.8 discloses another connector. The connector needs to be installed between a printhead carriage and a chip main control circuit board, and installation by a user is also difficult.

### SUMMARY

To resolve the foregoing problem, a first objective of the present invention is to provide a consumable container that can be installed conveniently by a user and that can effectively avoid a short circuit among multiple connection terminals caused by an ink drop falling on a chip.

A second objective of the present invention is to provide a consumable chip that can be installed in the foregoing consumable container.

A third objective of the present invention is to provide an inkjet printer that uses the foregoing consumable container.

### Technical Solutions

To implement the first objective of the present invention, a consumable container provided in the present invention includes a box body, a first circuit board is disposed on a sidewall of the box body, at least one first function contact part is disposed on the first circuit board, and the first function contact part is configured to be connected to a pin on a first side of a printhead carriage pin frame. A second circuit board is further disposed on the box body, the second circuit board and the first circuit board are separated from each other, at least one second function contact part is disposed on the second circuit board, and the second function contact part is configured to be electrically connected to a pin on a second side of the printhead carriage pin frame and/or a function contact point on a chip main control circuit board.

In a preferred solution, there are at least two first function contact parts, and multiple first function contact parts are arranged into one or two first straight lines. There are at least two second function contact parts, and multiple second function contact parts are arranged into one or two second straight lines. Along a height direction of the box body, the first straight line is located above the second straight line, or the first straight line is located below the second straight line.

In a further solution, a memory is disposed on the first circuit board, and the first function contact part is electrically connected to the memory; or a memory is disposed on the second circuit board, and the second function contact part is electrically connected to the memory.

In a further solution, the second function contact part includes a retractable conductive spring pin, a conductive sponge, or a conductive rubber.

In a further solution, a through hole is disposed at an upper end of the second circuit board, and the upper end of the second circuit board is fastened to a handle of the box body.

Preferably, a snap-fit hole and a snap-fit member are disposed on the handle of the box body, and the snap-fit member passes through the through hole at the upper end of the second circuit board and is snap-fit to the snap-fit hole on the handle of the box body.

In an optional solution, the upper end of the second circuit board is fixedly connected to the box body by using a fastening member. Preferably, the upper end of the second circuit board is fastened to the fastening member through bonding or screw connection.

In a further solution, a slide slot is disposed at an upper end of the box body, the upper end of the second circuit board is fastened to an installation member, a slide block is disposed on the installation member, and the slide block is slidably installed in the slide slot.

In a further solution, a fastening block is further disposed on the installation member, a clamping member is disposed at a lower end of the fastening block, and the clamping member is clamped at a lower end of the slide slot.

In an optional solution, the second function contact part abuts against an upper end of the pin on the second side of the printhead carriage pin frame. Preferably, a bevel is disposed at the upper end of the pin on the second side of the printhead carriage pin frame, and the second function contact part abuts against the bevel.

In a further solution, a weight block and a weight block slide slot are further disposed on the second circuit board, and the weight block may slide in the weight block slide slot. Preferably, the weight block slide slot extends in the height direction of the box body.

In a further solution, a push block is further disposed on the second circuit board, and a cross-section of the push block is a circular arc or trapezoidal shape.

In an optional solution, at least one spring plate is disposed on the second circuit board, a first portion of the spring plate is fastened to the second circuit board, a second portion of the spring plate is in a bent shape and overhangs the second circuit board, and the second function contact part is disposed in the second portion.

In a further solution, the first portion is fastened to the second circuit board in a patch manner.

In a further solution, an elastic snap-fit part is disposed in the first portion, a clamping slot is disposed in the second circuit board, and the elastic snap-fit part is snap-fit to the clamping slot.

In a further solution, an end of the first portion is flush with a lower end edge of the second circuit board, and forms a bent shape.

In a further solution, a guide block is disposed on the box body, the guide block has an inclined guide surface, and the guide surface is disposed on an upper edge of the second circuit board.

To implement the foregoing second objective, a consumable chip provided in the present invention includes a first circuit board, where at least one first function contact part is disposed on the first circuit board, and the first function contact part is configured to contact a pin on a first side of a printhead carriage pin frame; and a second circuit board, where the second circuit board and the first circuit board are separated from each other, at least one second function contact part is disposed on the second circuit board, and the second function contact part is configured to electrically contact a pin on a second side of the printhead carriage pin frame and/or a contact point on a chip main control circuit board.

In a further solution, there are at least two first function contact parts, and multiple first function contact parts are arranged into one or two first straight lines. There are at least two second function contact parts, and multiple second function contact parts are arranged into one or two second straight lines. Along a height direction of the consumable chip, the first straight line is located above the second straight line, or the first straight line is located below the second straight line.

In a still further solution, a memory is disposed on the first circuit board, and the first function contact part is electrically connected to the memory; or a memory is disposed on the second circuit board, and the second function contact part is electrically connected to the memory.

To implement the foregoing third objective, an inkjet printer provided in the present invention includes a printer body, where a chip main control circuit board and a printhead carriage are disposed in the printer body, a pin frame is disposed on the printhead carriage, and a pin is disposed on both sides of the printhead carriage pin frame; in addition, one or more of the foregoing consumable containers and/or one or more of the foregoing consumable chips are installed in the inkjet printer, and a lower end of a second circuit board is inserted between the chip main control circuit board and a pin on a second side of the printhead carriage pin frame.

### Beneficial Effects

When a consumable container is installed on an inkjet printer, a first circuit board is attached to a box body and is connected to a pin on a first side of a printhead carriage pin frame, and a second circuit board may be inserted between a pin on a second side of the printhead carriage pin frame and a chip main control circuit board of the inkjet printer. Because the second circuit board is thin, the second circuit board can be conveniently inserted into a gap between the pin on the second side of the printhead carriage pin frame and the chip main control circuit board, and installation of the second circuit board is convenient.

In addition, a first function contact part and a second function contact part are respectively disposed on the first circuit board and the second circuit board, and the first circuit board and the second circuit board are separated from each other by using the printhead carriage pin frame. Therefore, even if ink drops on the first circuit board or the second circuit board, a high-voltage signal is not to be loaded on a function contact point connected to a memory, and the memory is not to be damaged.

Because multiple function contact parts on the first circuit board and multiple function contact parts on the second circuit board are not on a same straight line, that is, there is a height difference between the first function contact part and the second function contact part, even if ink drops on the first function contact part or the second function contact part, the first function contact part and the second function contact part are not to be directly short-circuited, thereby effectively avoiding damage to the memory.

The memory is disposed on the first circuit board or the second circuit board, and a disposing position of the memory may be flexibly adjusted according to an actual use requirement, so that the second circuit board can be conveniently inserted into the gap between the pin on the second side of the printhead carriage pin frame and the chip main control circuit board.

In addition, by compressing these elastic conductive materials, the pin on the second side of the printhead carriage pin frame can improve connection flexibility between the second function contact part and the function contact point on the chip main control circuit board, so that the second function contact part and the function contact point on the chip main control circuit board can be in better contact.

And through cooperation between a snap-fit member and a snap-fit hole, fastened connection between the second circuit board and the consumable container is very simple, thereby facilitating assembly of the second circuit board.

A fastening member disposed in the present invention may increase connection reliability between the second circuit board and the box body of the consumable container, or the fastening member itself is a part of the box body. In this way, the second circuit board does not need be disposed on a handle, and a through hole does not need to be disposed, thereby reducing a possibility of deformation or breakage of the second circuit board.

In an embodiment, installation of the second circuit board is very convenient through cooperation between a slide slot and a slide block, thereby improving assembly efficiency of the consumable container.

In another embodiment, the slide block can be prevented from sliding out of the slide slot by using a clamping member, thereby improving installation reliability of the second circuit board.

In a manner in which the second function contact part abuts against a bevel, connection between the second function contact part and the pin on the second side of the printhead carriage pin frame is facilitated, so that the connection between the second function contact part and the pin on the second side of the printhead carriage pin frame is more flexible.

By using a weight block, the second circuit board can be better inserted into the gap between the pin on the second side of the printhead carriage pin frame and the chip main control circuit board, so as to prevent a lower end of the second circuit board from touching an upper surface of the chip main control circuit board during installation.

In a process of inserting the second circuit board into the gap between the pin on the second side of the printhead carriage pin frame and the chip main control circuit board, a push block first causes the second circuit board to undergo elastic deformation, and then causes the second circuit board to recover from elastic deformation, so as to guide the lower end of the second circuit board to avoid the upper surface of the chip main control circuit board. In addition, a push block having a circular arc or trapezoidal cross-section may allow a user to install or remove the box body more smoothly.

A bent spring plate is disposed on the second circuit board, so that a length of the spring plate can be increased, and a proper spring force is formed in a limited space, so that the second function contact part can be better connected to the pin on the second side of the printhead carriage pin frame. In addition, the spring plate is fastened to the second circuit board in a patch manner, so that the length of the spring plate can be reduced, a deformation possibility can be reduced, and strength of the spring plate can be increased. An end of a first portion of the spring plate is flush with a lower end edge of the second circuit board, which may provide a sufficient bending and deformation space for the spring plate, so that the second function contact part is more reliably connected to the pin on the second side of the printhead carriage pin frame.

### BRIEF DESCRIPTION OF THE DRAWINGS

FIG. 1 is a structural diagram of an existing inkjet printer.

FIG. 2 is a structural diagram of an existing ink cartridge.

FIG. 3 is a structural diagram of an existing ink cartridge chip.

FIG. 4 is an exploded structural diagram of a printhead carriage pin frame of an existing inkjet printer and a chip main control circuit board from a first angle of view.

FIG. 5 is an exploded structural diagram of a printhead carriage pin frame of an existing inkjet printer and a chip main control circuit board from a second angle of view.

FIG. 6 is a structural diagram of a first embodiment of a consumable container, a printhead carriage pin frame, and a main control circuit board according to the present invention.

FIG. 7 is an exploded structural diagram of a first embodiment of a consumable container, a printhead carriage pin frame, and a main control circuit board according to the present invention.

FIG. 8 is a structural diagram of a first embodiment of a consumable container according to the present invention from a first angle of view.

FIG. 9 is an exploded structural diagram of a first embodiment of a consumable container according to the present invention from a first angle of view.

FIG. 10 is an exploded structural diagram of a first embodiment of a consumable container according to the present invention from a second angle of view.

FIG. 11 is a structural diagram of a first embodiment of a consumable container according to the present invention from a second angle of view.

FIG. 12 is a structural diagram of a printhead carriage pin frame according to a first embodiment of an inkjet printer according to the present invention.

FIG. 13 is a structural diagram of a printhead carriage pin frame and a second circuit board according to a first embodiment of an inkjet printer according to the present invention from a first angle of view.

FIG. 14 is a structural diagram of a printhead carriage pin frame and a second circuit board according to a first embodiment of an inkjet printer according to the present invention from a second angle of view.

FIG. 15 is a structural diagram of a second embodiment of a consumable container according to the present invention.

FIG. 16 is an exploded structural diagram of a second embodiment of a consumable container according to the present invention.

FIG. 17 is a structural diagram of a third embodiment of a consumable container according to the present invention from a first angle of view.

FIG. 18 is a structural diagram of a third embodiment of a consumable container according to the present invention from a second angle of view.

FIG. 19 is an exploded structural diagram of a third embodiment of a consumable container according to the present invention.

FIG. 20 is a partial exploded structural diagram of a third embodiment of a consumable container according to the present invention.

FIG. 21 is a structural diagram of an installation member according to a third embodiment of a consumable container according to the present invention.

FIG. 22 is a structural diagram of a fourth embodiment of a consumable container according to the present invention.

FIG. 23 is a structural diagram of a second circuit board and a printhead carriage pin frame according to a fourth embodiment of a consumable container according to the present invention.

FIG. 24 is a partially enlarged view of FIG. 23.

FIG. 25 is a structural diagram of a fifth embodiment of a consumable container according to the present invention.

FIG. 26 is an exploded structural diagram of a second circuit board according to a fifth embodiment of a consumable container according to the present invention.

FIG. 27 is a structural diagram of a sixth embodiment of a consumable container according to the present invention.

FIG. 28 is an exploded structural diagram of a sixth embodiment of a consumable container according to the present invention.

FIG. 29 is a structural diagram of a printhead carriage pin frame in an installation process according to a first embodiment of a consumable container according to the present invention.

FIG. 30 is a schematic structural diagram of a second circuit board and a printhead carriage pin frame at a first stage of an installation process according to a first embodiment of a consumable container according to the present invention.

FIG. 31 is a schematic structural diagram of a second circuit board and a printhead carriage pin frame at a second stage of an installation process according to a first embodiment of a consumable container according to the present invention.

FIG. 32 is a schematic structural diagram of a second circuit board and a printhead carriage pin frame at a third stage of an installation process according to a first embodiment of a consumable container according to the present invention.

FIG. 33 is a schematic structural diagram of a second circuit board and a printhead carriage pin frame at a fourth stage of an installation process according to a first embodiment of a consumable container according to the present invention.

FIG. 34 is a structural diagram of a seventh embodiment of a consumable container according to the present invention.

FIG. 35 is a structural diagram of a second circuit board and a spring plate according to a seventh embodiment of a consumable container according to the present invention.

FIG. 36 is an exploded structural diagram of a second circuit board and a spring plate according to a seventh embodiment of a consumable container according to the present invention.

FIG. 37 is an exploded structural diagram of a second circuit board and one spring plate according to a seventh embodiment of a consumable container according to the present invention.

FIG. 38 is a structural diagram of a partial structure of an eighth embodiment of a consumable container according to the present invention.

FIG. 39 is an exploded structural diagram of a partial structure of an eighth embodiment of a consumable container according to the present invention.

FIG. 40 is a partially enlarged view of FIG. 38.

FIG. 41 is an exploded structural diagram of a handle and a guide block according to an eighth embodiment of a consumable container according to the present invention from a first angle of view.

FIG. 42 is an exploded structural diagram of a handle and a guide block according to an eighth embodiment of a consumable container according to the present invention from a second angle of view.

FIG. 43 is a structural diagram of a second circuit board according to an eighth embodiment of a consumable container according to the present invention.

FIG. 44 is an exploded structural diagram of a second circuit board according to an eighth embodiment of a consumable container according to the present invention.

FIG. 45 is a structural diagram of a second circuit board according to a ninth embodiment of a consumable container according to the present invention.

FIG. 46 is an exploded structural diagram of a second circuit board according to a ninth embodiment of a consumable container according to the present invention.

FIG. 47 is a partially enlarged view of a tenth embodiment of a consumable container according to the present invention.

FIG. 48 is a partially enlarged and exploded view of a tenth embodiment of a consumable container according to the present invention.

FIG. 49 is a structural diagram of a second circuit board according to an eleventh embodiment of a consumable container according to the present invention from a first angle of view.

FIG. 50 is a structural diagram of a second circuit board according to an eleventh embodiment of a consumable container according to the present invention from a second angle of view.

FIG. 51 is a structural diagram of a conductive spring pin according to the first embodiment of a consumable container according to the present invention.

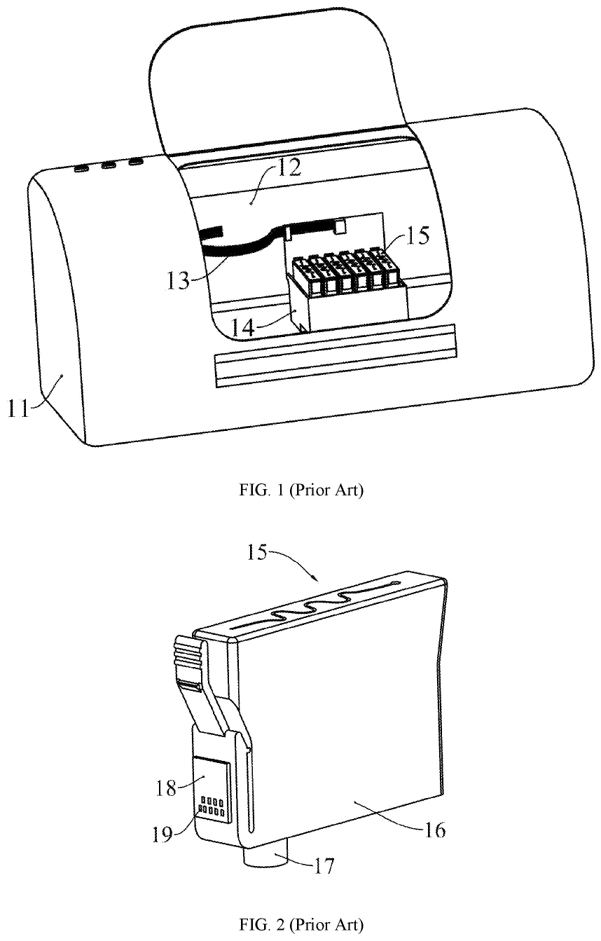

The following further describes the present invention with reference to the accompanying drawings and embodiments.

### DETAILED DESCRIPTION OF THE EMBODIMENTS

### First Embodiment

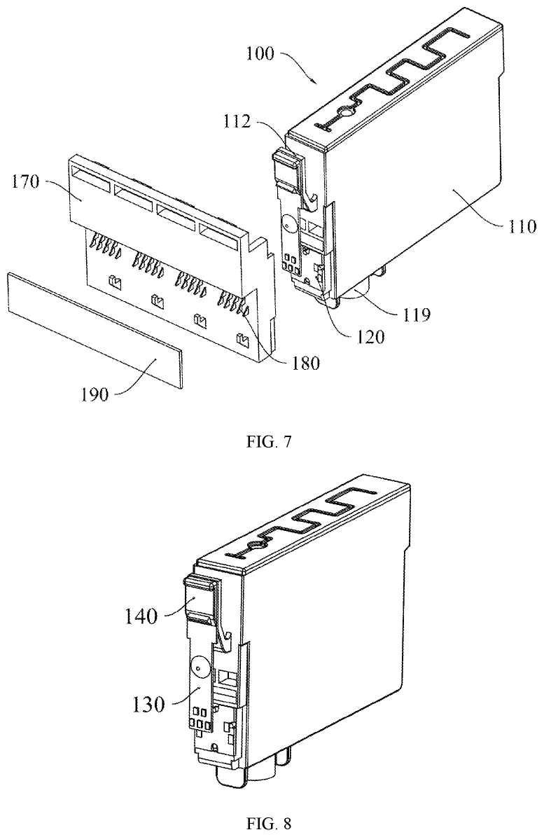

An inkjet printer in this embodiment is provided with a printer body, and a printhead carriage is formed in the printer body. Referring to FIG. 6 and FIG. 7, multiple ink cartridges 100 are detachably installed in the printhead carriage, and each ink cartridge 100 has one box body 110. The box body 110 encloses to form a cavity that accommodates ink, an ink outlet 119 that is in communication with the cavity is disposed below the cavity, and the ink in the cavity may flow out through the ink outlet. A handle 112 is disposed at an upper end of the box body 110. Preferably, the handle 112 is an elastic handle, and can be pressed to elastically deform. In addition, a first circuit board 120 is detachably installed on an outer wall of a lower end of the box body 110.

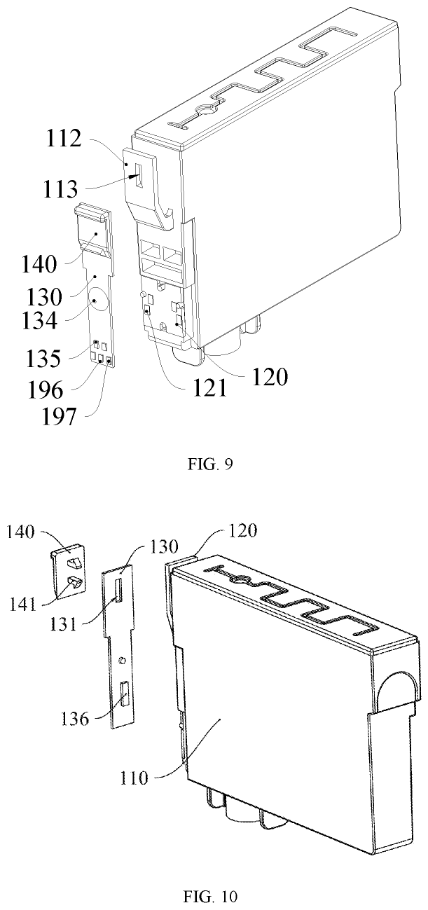

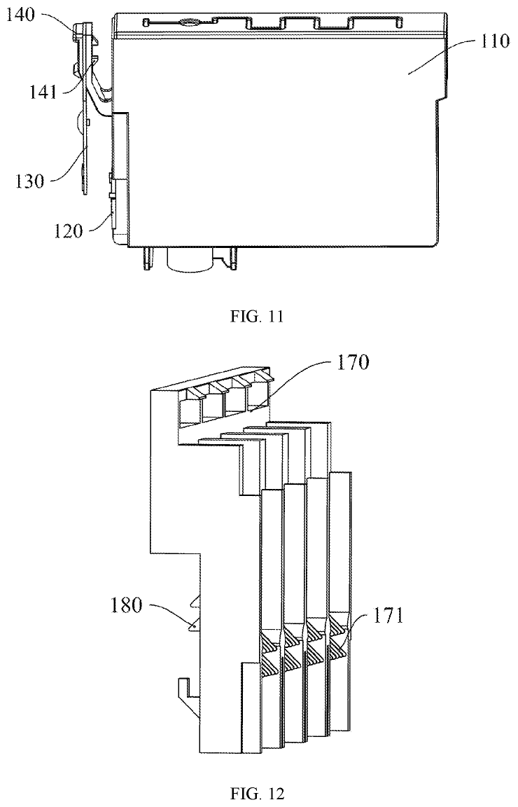

Referring to FIG. 8 and FIG. 9, a second circuit board 130 is further disposed on the ink cartridge 100, and an upper end of the second circuit board 130 is fastened to the handle 112. A snap-fit hole 113 is disposed on the handle 112, and a snap-fit member 140 is disposed outside the second circuit board 130. Referring to FIG. 10 and FIG. 11, the snap-fit member 140 includes two snap-fit parts 141, and a through hole 131 is also disposed at the upper end of the second circuit board 130. The through hole 131 is directly opposite the snap-fit hole 113, and shapes and sizes of the through hole 131 and the snap-fit hole 113 are exactly the same. The snap-fit part 141 may pass through the through hole 131 and the snap-fit hole 113, and a locking buckle is disposed at a free end of the snap-fit part 141. After the snap-fit part 141 passes through the snap-fit hole 113 of the handle 112, the locking buckle is located on a side of the handle 112 close to the box body 110. In this way, the second circuit board 130 can be fastened to the handle 112 by using the snap-fit member 140.

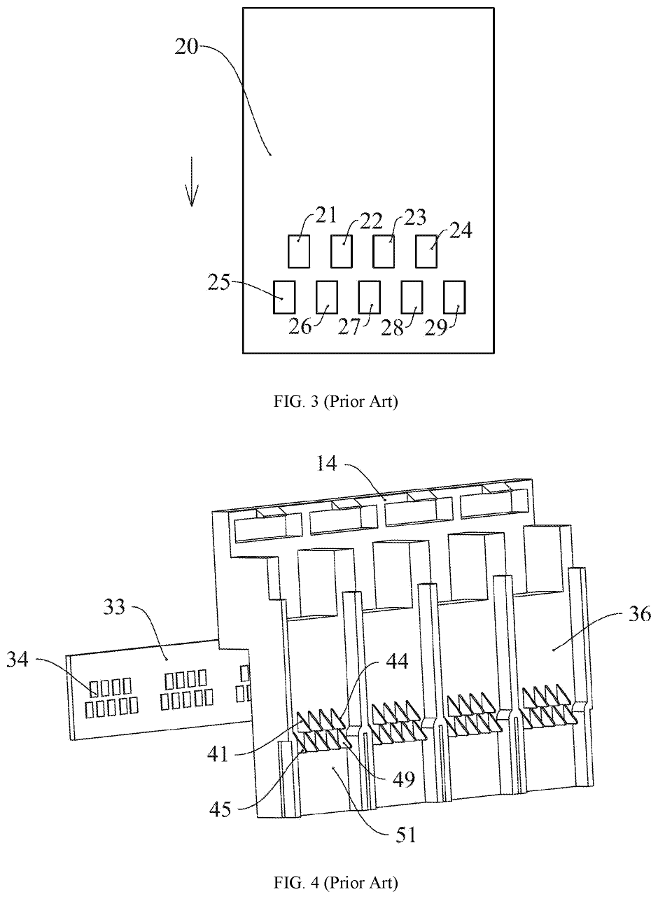

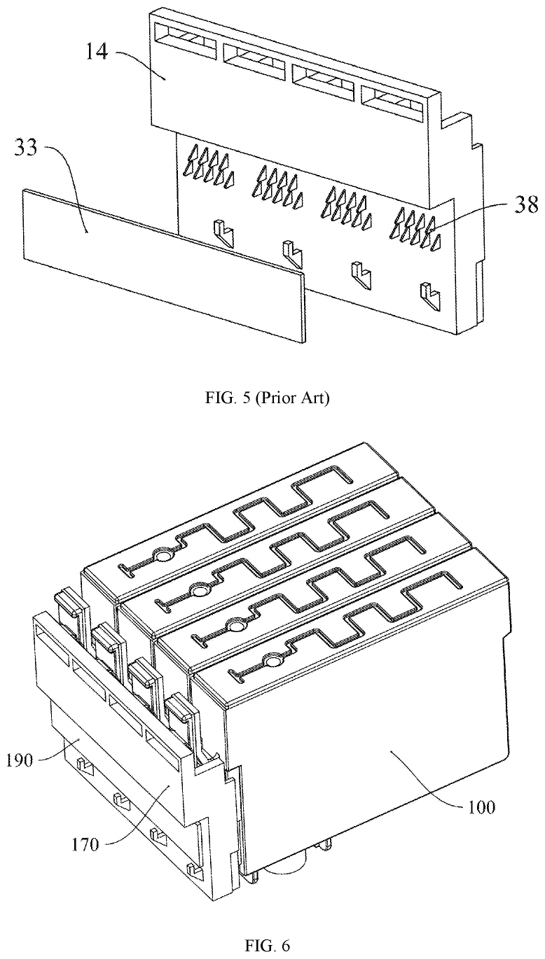

In this embodiment, four first function contact parts 121 are disposed on the first circuit board 120, and the four first function contact parts 121 are arranged into two straight lines, where the two straight lines are first straight lines. Preferably, the four first function contact parts 121 respectively include detection contact parts and high-voltage contact parts. It may be understood that the four first function contact parts 121 are equivalent to detection terminals and high-voltage terminals on an existing ink cartridge chip, that is, the terminals 21, 24, 25, and 29 in FIG. 3.

A memory 136 and multiple second function contact parts 135 are disposed on the second circuit board 130. In this embodiment, there are five second function contact parts 135, and the five second function contact parts 135 are electrically connected to the memory 136. It can be seen from FIG. 9 that the five second function contact parts 135 are arranged into two straight lines, and the two straight lines are second straight lines. It may be understood that the five second function contact parts 135 are equivalent to connection terminals that are on the existing ink cartridge chip and that are connected to the memory, and include a power supply terminal, a ground terminal, a data terminal, a chip-select terminal, and a clock signal terminal, that is, the terminals 22, 23, 26, 27, and 28 in FIG. 3.

It can be learned that, in this embodiment, nine connection terminals that are originally disposed on a conventional ink cartridge chip are separately disposed on the first circuit board 120 and the second circuit board 130, the first function contact parts 121 loaded with a high-voltage signal are disposed on the first circuit board 120, and multiple second function contact parts 135 connected to the memory 136 are disposed on the second circuit board 130. It can be seen from FIG. 11, the first circuit board 120 and the second circuit board 130 are separated from each other. Therefore, even if ink drops on the first circuit board 120 or the second circuit board 130, the memory 136 is not to be damaged because the memory 136 is loaded with an excessively high voltage.

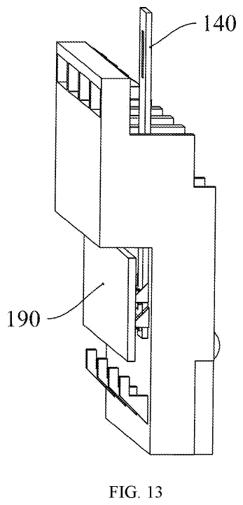

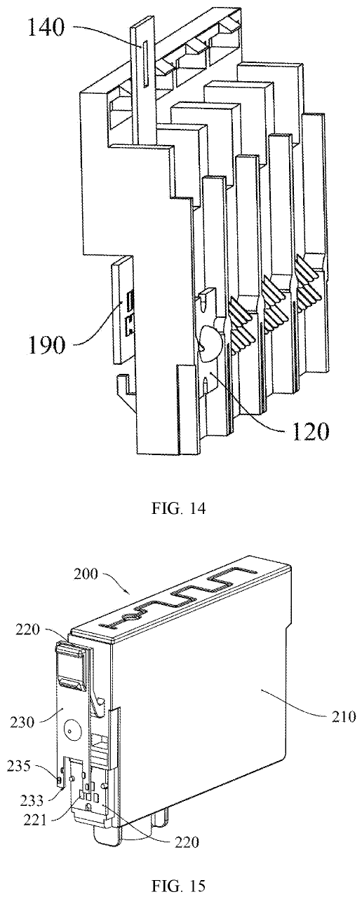

Referring to FIG. 7 and FIG. 12, multiple pins 171 are disposed on a first side of a printhead carriage pin frame 170, multiple pins 180 are disposed on a second side of the printhead carriage pin frame 170, and a chip main control circuit board 190 is located on the second side of the printhead carriage pin frame 170. Referring to FIG. 13 and FIG. 14, the first circuit board 120 is disposed on the first side of the printhead carriage pin frame 170. Therefore, the first function contact parts 121 are in electrical contact with the multiple pins 171 on the first side. After the ink cartridge 100 is installed in the inkjet printer, the second circuit board 130 is inserted between the second side of the printhead carriage pin frame 170 and the chip main control circuit board 190. Therefore, the multiple pins 180 on the second side of the printhead carriage pin frame 170 compress the multiple second function contact parts 135 in a direction toward the chip main control circuit board 190, so that the multiple second function contact parts 135 are electrically connected to multiple contact points 34 on the chip main control circuit board 190. A rear surface of each of the multiple second function contact parts 135 on the second circuit board 130, that is, a surface of the second circuit board 130 facing the ink cartridge 100, is insulated. Therefore, after the second circuit board 130 is installed in place, there is no electrical connection between multiple pins on the first side that are corresponding to the pins compressing the multiple second function contact parts 135, that is, the pins 41, 44, 45, and 49 in FIG. 4. In this way, even if ink drops on any pin on the first side of the printhead carriage pin frame 170, the memory 136 is not to be damaged because of a high voltage.

It can be seen from FIG. 12 that heights of the pins 171 and 180 on two sides of the printhead carriage pin frame 170 are different. In a height direction of the ink cartridge 100, the multiple pins 180 disposed on the second side of the printhead carriage pin frame 170 are located above the multiple pins 171 disposed on the first side of the printhead carriage pin frame 170. Therefore, in the height direction of the ink cartridge 100, the multiple second function contact parts 135 of the second circuit board 130 are located above the first function contact parts 121 of the first circuit board 120, that is, the two second straight lines are located above the two first straight lines. It may be understood that the multiple first function contact parts 121 and the multiple second function contact parts 135 are not on a same straight line.

Preferably, the second circuit board 130 is a rigid circuit board with a relatively thin thickness. When the ink cartridge 100 is installed in the inkjet printer, a lower end of the second circuit board 130 may be inserted into a gap between the printhead carriage pin frame 170 and the chip main control circuit board 190, so that the multiple second function contact parts 135 are in electrical contact with the multiple contact points 34 on the chip main control circuit board 190. To enable better contact between the second function contact part 135 and the contact point 34 on the chip main control circuit board 190, the second function contact part 135 may be disposed as a retractable conductive spring pin structure. As shown in FIG. 51, the retractable conductive spring pin 191 includes a sleeve 192 fastened to the second circuit board 130, a retractable part 194 is disposed in the sleeve 192, and the retractable part 194 has a spring 193 disposed close to a bottom of the sleeve 192, so that the retractable part 194 is retractable relative to the sleeve 192 by using the spring 193. The conductive spring pin structure is designed to facilitate installation of the second circuit board 130, and also facilitates more flexible contact between the second function contact part 135 and the contact point 34 on the chip main control circuit board 190.

It should be noted that a specific form of the second function contact part 135 is not limited in the present invention. For example, the second function contact part 135 may alternatively be a conductive spring plate, a conductive sponge 196, a conductive rubber 197, or a protrusion of a conductive metal, for example, a tin point, that is fastened at a corresponding position of the second circuit board 130, or may be a strip-shaped conductive spring plate that extends from the second circuit board 130 and that is electrically connected to a contact point 34 at a corresponding position on the chip main control circuit board 190, or a combination of the foregoing conductive elastic materials, provided that the multiple second function contact parts 135 can be in stable electrical contact with multiple corresponding contact points 34 on the chip main control circuit board 190.

When the ink cartridge 100 is installed in the inkjet printer, the lower end of the second circuit board 130 may be inserted into the printhead carriage pin frame 170, and the box body 110 is installed in an installation cavity corresponding to the printhead carriage pin frame 170. With downward propulsion of the ink cartridge 100, the second circuit board 130 is also inserted into the gap between the printhead carriage pin frame 170 and the chip main control circuit board 190, so as to implement contact between the second function contact part 135 and the pin 180 on the second side of the printhead carriage pin frame 170. It can be learned that when the ink cartridge 100 is installed, a connector does not need to be installed on the printhead carriage in advance. Installation of the second circuit board 130 is performed in synchronization with installation of the ink cartridge 100, and the second circuit board 130 is fastened to the handle 112. Therefore, installation of the second circuit board 130 is very simple and convenient, which can avoid damage to the inkjet printer due to incorrect installation of the connector.

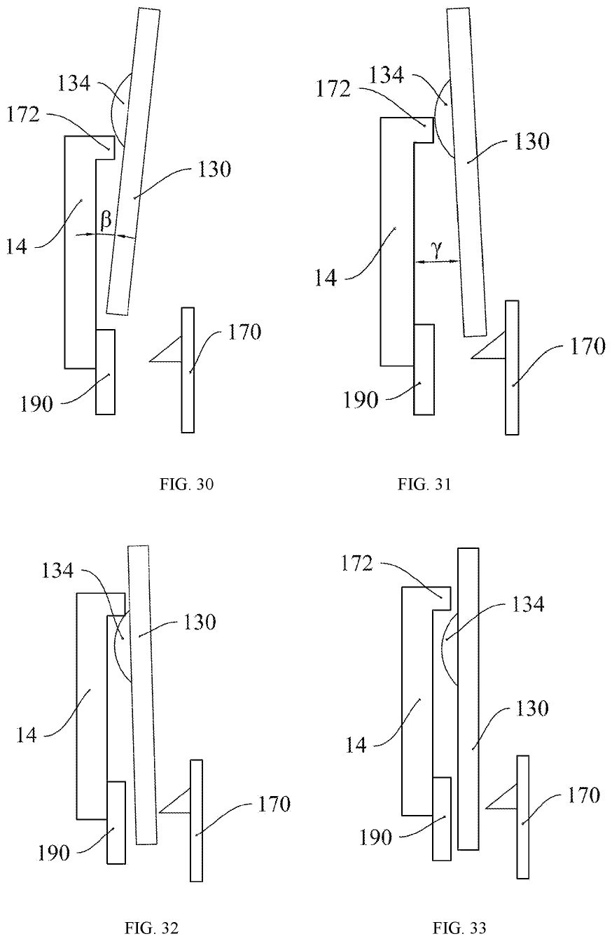

Referring to FIG. 9 and FIG. 29, the second circuit board 130 further includes a push block 134. In a process of installing the ink cartridge 100, the ink cartridge 100 is not always pushed vertically downward, but is first pre-installed at a predetermined angle R above an installation cavity of a corresponding color, and then forcibly pushed vertically downward until installation is in place. To simplify the description, referring to FIG. 30 to FIG. 33, FIG. 30 is a schematic diagram when the second circuit board 130 starts to be inserted. It may be learned that, in this case, an end of the second circuit board 130 directly faces an upper edge of the chip main control circuit board 190. If there is no push block 134, in a process of continuous insertion, the end of the second circuit board 130 abuts against the upper edge of the chip main control circuit board 190, and therefore, the second circuit board 130 cannot continue to be inserted downward, which causes an installation failure. As the installation and insertion process progresses, referring to FIG. 31, in this case, a handle clamping position 172 on the printhead carriage 14 contacts the push block 134, and pushes the push block 134 in a direction toward the box body 110. Because the upper end of the second circuit board 130 is fastened to the handle 112, and the thickness of the second circuit board 130 is relatively thin and has elasticity and toughness, after the push block 134 on the second circuit board 130 receives a push force in the direction toward the box body 110, elastic deformation occurs, and an included angle between the second circuit board 130 and the printhead carriage 14 changes from β to γ, so as to guide the end of the second circuit board 130 from facing the upper edge of the chip main control circuit board 190 to directly facing the gap between the chip main control circuit board 190 and the second side of the printhead carriage pin frame 170, so that the second circuit board 130 can continue to be inserted. When a highest point of the push block 134 is in tight contact with the handle clamping position 172 on the printhead carriage 14, the included angle γ reaches a maximum value. As installation continues, because a height at which the push block 134 is in contact with the handle clamping position 172 on the printhead carriage 14 starts to decrease, the angle γ between the second circuit board 130 and the printhead carriage 14 starts to decrease. Referring to FIG. 32, in this case, the end of the second circuit board 130 falls into the gap between the chip main control circuit board 190 and the second side of the printhead carriage pin frame 170, and will not touch the upper edge of the chip main control circuit board 190 any longer. Finally, after installation is in place, the push block 134 is no longer in contact with the handle clamping position 172 on the printhead carriage 14, and the second circuit board 130 recovers from elastic deformation. Therefore, the included angle γ between the second circuit board 130 and the printhead carriage 14 becomes 0, that is, the second circuit board 130 is parallel to multiple terminals on the printhead carriage 14 and the chip main control circuit board 190. Finally, referring to FIG. 33, the multiple pins on the second side of the printhead carriage pin frame 170 abut against a rear part of the second circuit board 130, and push the multiple second function contact parts 135 located on the second circuit board 130 in a direction toward the chip main control circuit board 190, so that the multiple second function contact parts 135 and the multiple contact points 34 on the chip main control circuit board 190 implement stable electrical contact. Preferably, a cross-section of the push block 134 is a circular arc or trapezoidal shape, so that a process of inserting and removing the second circuit board 130 is smoother.

### Second Embodiment

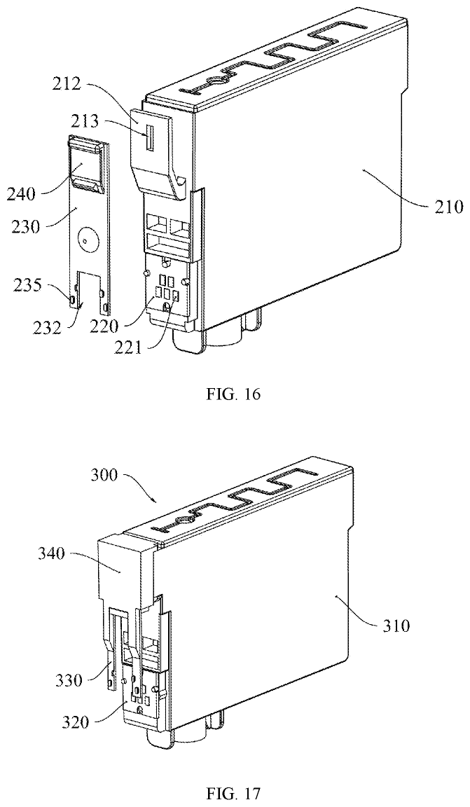

Referring to FIG. 15 and FIG. 16, an ink cartridge 200 in this embodiment has a box body 210, and the box body 210 encloses to form a cavity that accommodates ink. A handle 212 is disposed at an upper end of the box body 210, and a snap-fit hole 213 is disposed on the handle 212. A first circuit board 220 is detachably installed on an outer wall of a lower end of the box body 210.

A second circuit board 230 is further disposed on the ink cartridge 200, and an upper end of the second circuit board 230 is fastened to the handle 212. A snap-fit member 240 is disposed outside the second circuit board 230, and the snap-fit member 240 includes two snap-fit parts. A through hole is also disposed at the upper end of the second circuit board 230, and the second circuit board 230 can be fastened to the handle 212 by using the snap-fit member 240.

Different from the first embodiment, a memory and five first function contact parts 221 are disposed on the first circuit board 220 in this embodiment, and the five first function contact parts 221 are arranged in two first straight lines and are electrically connected to the memory. In addition, the first function contact parts 221 are electrically connected to pins on a first side of a printhead carriage pin frame 170.

Four second function contact parts 235 are disposed on the second circuit board 230, and the four second function contact parts 235 are arranged in two rows, to form two second straight lines. The four second function contact parts 235 are corresponding to detection terminals and high-voltage terminals on a conventional ink cartridge chip. In addition, an opening 232 is formed on the second circuit board 230. In this embodiment, the two first straight lines are located below the two second straight lines.

It may be understood that the first function contact parts 221 of the first circuit board 220 and the second function contact parts 235 of the second circuit board 230 in this embodiment are inversely disposed from those in the first embodiment.

### Third Embodiment

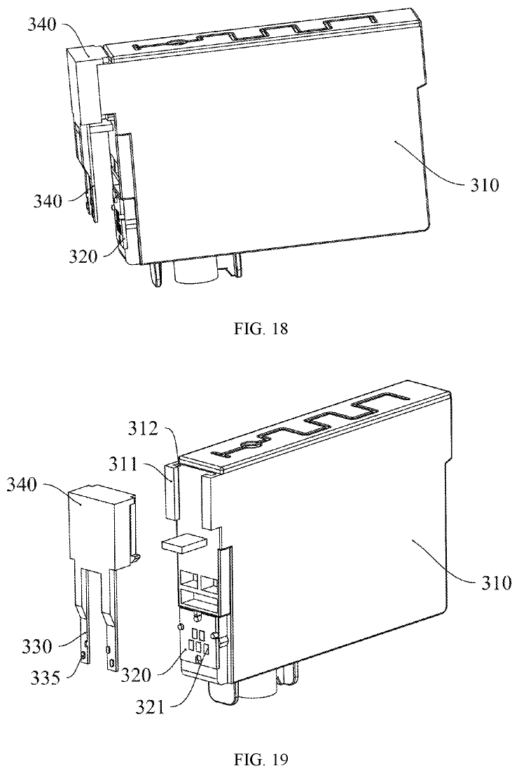

Referring to FIG. 17 to FIG. 19, an ink cartridge 300 in this embodiment has a box body 310, and the box body 310 encloses to form a cavity that accommodates ink. A first circuit board 320 is detachably installed on an outer wall of a lower end of the box body 310, and five first function contact parts 321 are disposed on the first circuit board 320. In addition, a memory is disposed on the first circuit board 320, the five first function contact parts 321 are electrically connected to the memory, and the five first function contact parts 321 are arranged in two first straight lines. In addition, the first function contact parts 321 are electrically connected to pins on a first side of a printhead carriage pin frame.

A second circuit board 330 is further disposed on the box body 310, four second function contact parts 335 are disposed at a lower end of the second circuit board 330, and the four second function contact parts 335 are arranged in two rows, to form two second straight lines. The four second function contact parts 335 are corresponding to detection terminals and high-voltage terminals on a conventional ink cartridge chip. In this embodiment, the two first straight lines are located below the two second straight lines.

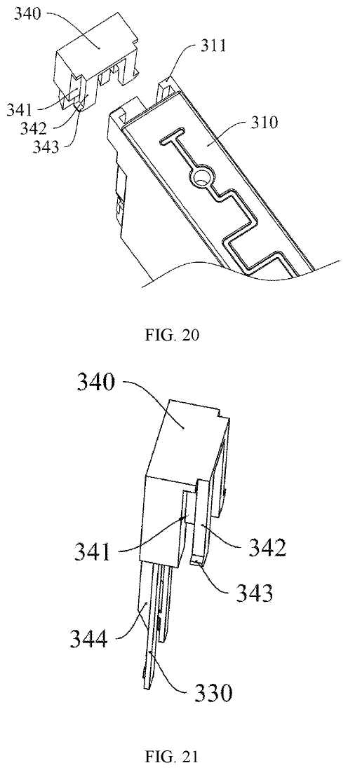

Different from the second embodiment, a handle is not disposed on the box body 310 in this embodiment. Therefore, the second circuit board 330 needs to be fastened to an upper end of the box body 310 by using a installation member 340. Referring to FIG. 19 to FIG. 21, the installation member 340 is installed at the upper end of the box body 310, and two slide slots 311 are disposed at the upper end of the box body 310. A slide block 341 is disposed on the installation member 340. The slide slot 311 may enable the slide block 341 to slide thereinto, so that the installation member 340 can be installed at the upper end of the box body 310.

A fastening block 342 is further disposed on the installation member 340, a clamping member 343 is disposed at a lower end of the fastening block 342, and the clamping member 343 may be clamped at a lower end of the slide slot 311. In this way, when the installation member 340 is installed in the ink cartridge 300, the slide block 341 may slide into the slide slot 311. When a lower end of the slide block 341 reaches the lower end of the slide slot 311, the clamping member 343 is clamped at the lower end of the slide slot 311, thereby implementing limiting of the installation member 340.

An upper end of the second circuit board 330 is fastened to the installation member 340. Therefore, the second circuit board 330 is fastened to the box body 310 by using the installation member. In addition, a reinforcing rib 344 is further disposed on the installation member 340, and the reinforcing rib 344 is located on a side of the second circuit board 330, so as to improve strength of the second circuit board 330, which is also conducive to installation of the second circuit board 330.

### Fourth Embodiment

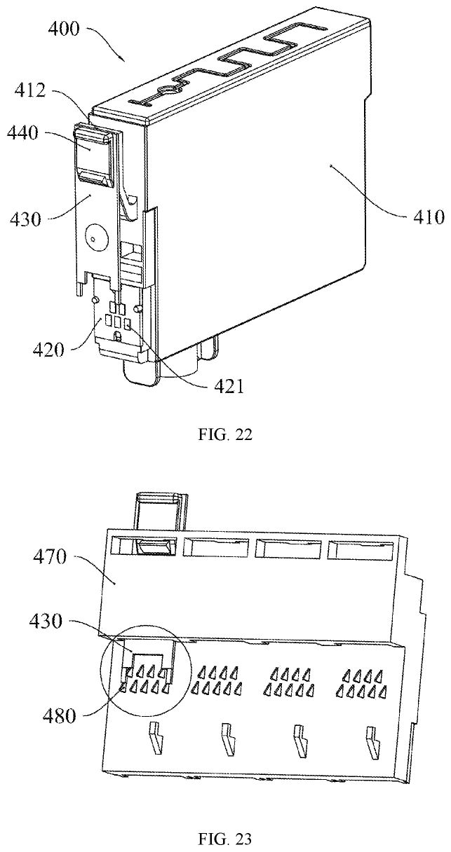

Referring to FIG. 22, an ink cartridge 400 in this embodiment has a box body 410, and the box body 410 encloses to form a cavity that accommodates ink. A handle 412 is disposed at an upper end of the box body 410, a first circuit board 420 is detachably installed on an outer wall of a lower end of the box body 410, and five first function contact parts 421 are disposed on the first circuit board 420. In addition, a memory is disposed on the first circuit board 420, the five first function contact parts 421 are electrically connected to the memory, and the five first function contact parts 421 are arranged in two first straight lines. In addition, the first function contact parts 421 are electrically connected to pins on a first side of a printhead carriage pin frame 470.

A second circuit board 430 is further disposed on the ink cartridge 400, and an upper end of the second circuit board 430 is fastened to the handle 412. A snap-fit member 440 is disposed outside the second circuit board 430, and the snap-fit member 440 includes two snap-fit parts. A through hole is also disposed at the upper end of the second circuit board 430, and the second circuit board 430 can be fastened to the handle 412 by using the snap-fit member 440.

Different from the second embodiment, multiple second function contact parts of the second circuit board 430 in this embodiment are not contact points or spring pins disposed on a surface of the second circuit board 430, but a layer of copper foil disposed on a lower surface of the second circuit board 430. In addition, the multiple second function contact parts on the second circuit board 430 in this embodiment are first electrically connected to multiple pins on a second side of the printhead carriage pin frame and then electrically connected to multiple contact points on a chip main control circuit board, instead of being directly electrically connected to the multiple contact points on the chip main control circuit board. Referring to FIG. 23 and FIG. 24, multiple pins 480 on the second side of the printhead carriage pin frame 470 are generally triangular, and each of the pins 480 has a bevel 481. Preferably, the bevel 481 is inclined from top to bottom along a height direction of the box body 410.

A copper foil is disposed on the lower surface of the second circuit board 430 as a second function contact part 435, and the second function contact part 435 is in contact with the bevel 481 of the pin 480, so that the second function contact part 435 is electrically connected to the pin 480.

It may be understood that, if a preset insertion position of the second circuit board 430 is close to the top of the pin 480 on the second side of the printhead carriage pin frame 470, the multiple second function contact parts 435 may be simultaneously electrically connected to the multiple pins 480 on the second side of the printhead carriage pin frame 470 and the multiple contact points on the chip main control circuit board, and a function of the second circuit board 430 can also be implemented. Certainly, the multiple second function contact parts 435 may be electrically connected to only the multiple contact points on the chip main control circuit board, but not to the multiple pins 480 on the second side of the printhead carriage pin frame 470.

### Fifth Embodiment

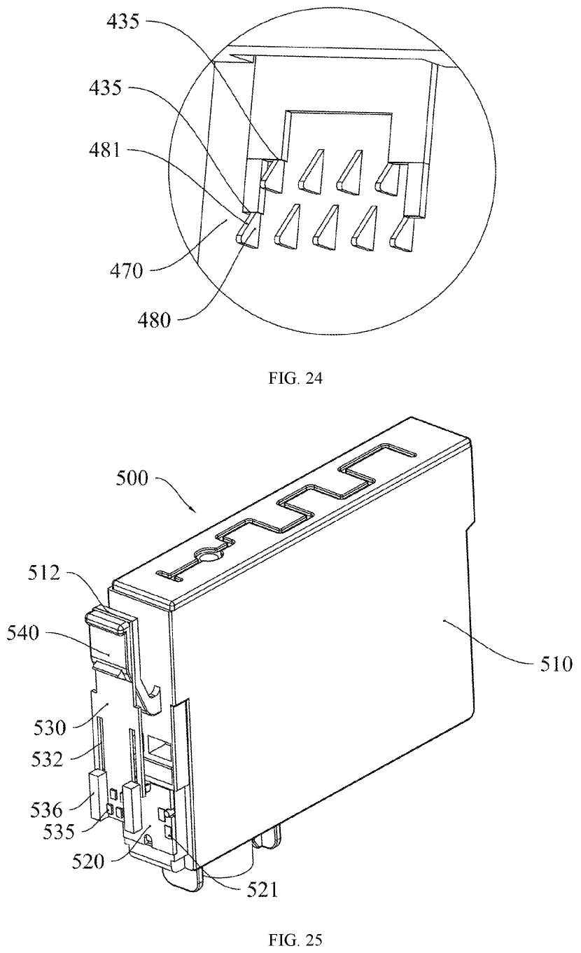

Referring to FIG. 25, an ink cartridge 500 in this embodiment has a box body 510, and the box body 510 encloses to form a cavity that accommodates ink. A handle 512 is disposed at an upper end of the box body 510, a first circuit board 520 is detachably installed on an outer wall of a lower end of the box body 510, four first function contact parts 521 are disposed on the first circuit board 520, and the four first function contact parts 521 are arranged in two first straight lines. In addition, the first function contact parts 521 are electrically connected to pins on a first side of a printhead carriage pin frame.

A second circuit board 530 is further disposed on the ink cartridge 500, and an upper end of the second circuit board 530 is fastened to the handle 512. Five second function contact parts 535 are disposed at a lower end of the second circuit board 530, and a memory is disposed on the second circuit board 530. The five second function contact parts 535 are electrically connected to the memory, and the five second function contact parts 535 are arranged in two second straight lines. Along a height direction of the box body 510, the two second straight lines are above the two first straight lines. The five second function contact parts 535 are electrically connected to multiple pins on a second side of the printhead carriage pin frame.

A snap-fit member 540 is disposed outside the second circuit board 530, and the snap-fit member 540 includes two snap-fit parts. A through hole is also disposed at the upper end of the second circuit board 530, and the second circuit board 530 can be fastened to the handle 512 by using the snap-fit member 540.

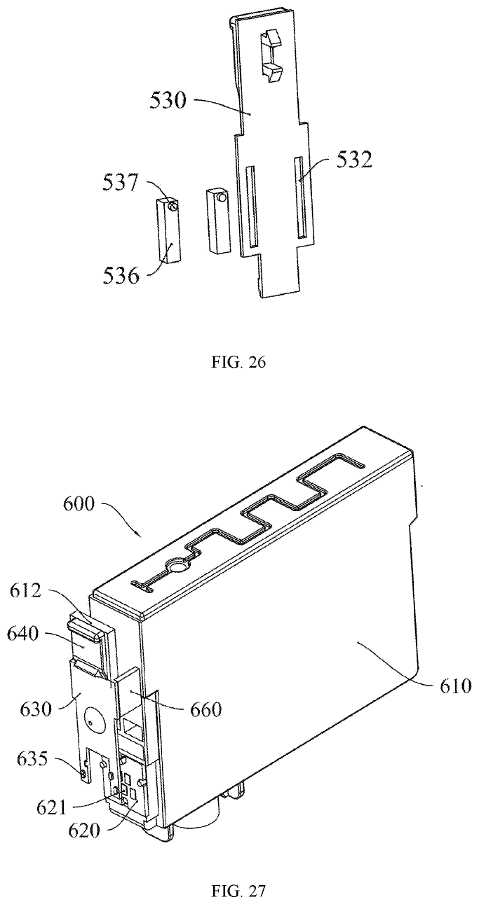

Different from the foregoing first embodiment to fourth embodiment, in this embodiment, a push block is not disposed on the second circuit board 530. Instead, two weight blocks 536 are used to replace a function of the push block. Each weight block 536 is strip-shaped, and extends in the height direction of the box body 510. Preferably, the two weight blocks 536 may slide up and down in a length direction of the second circuit board 530. Therefore, two weight block slide slots 532 are further disposed on the second circuit board 530, and the two weight block slide slots 532 are parallel to each other and are respectively located on two sides in a width direction of the second circuit board 530. Referring to FIG. 26, one slide block 537 is disposed at an upper end of each weight block 532, and the slide block 537 may pass through the weight block slide slot 532 and may slide up and down along the weight block slide slot 532, thereby driving the weight block 536 to slide up and down.

Before the ink cartridge 500 is installed in an inkjet printer, the weight block 536 slides to a lowest end of the weight block slide slot 532 due to gravity, and during installation of the ink cartridge 500 to the inkjet printer, the second circuit board 530 is installed in an extended posture due to the weight block 536. After the second circuit board 530 is inserted into a gap between the pin on the second side of the printhead carriage pin frame and the chip main control circuit board, the weight block 536 abuts against an upper end of the chip main control circuit board. As the second circuit board 530 continues to move downward, the weight block 536 moves upward along the weight block slide slot 532, so as to avoid continuous sliding downward of the second circuit board 530.

### Sixth Embodiment

Referring to FIG. 27, an ink cartridge 600 in this embodiment has a box body 610, and the box body 610 encloses to form a cavity that accommodates ink. A handle 612 is disposed at an upper end of the box body 610, a first circuit board 620 is detachably installed on an outer wall of a lower end of the box body 610, five first function contact parts 621 are disposed on the first circuit board 620, and the five first function contact parts 621 are arranged in two first straight lines. A memory is disposed on the first circuit board 620, and the five first function contact parts 621 are electrically connected to the memory. In addition, the five first function contact parts 621 are electrically connected to pins on a first side of a printhead carriage pin frame.

A second circuit board 630 is further disposed on the ink cartridge 600. Different from the foregoing first embodiment to fifth embodiment, an upper end of the second circuit board 630 is not fastened to the handle 612, but is fastened to two fastening members 660. Four second function contact parts 635 are disposed at a lower end of the second circuit board 630, and the four second function contact parts 635 are arranged in two second lines. Along a height direction of the box body 610, the two second straight lines are above the two first straight lines. The four second function contact parts 635 are electrically connected to multiple pins on a second side of the printhead carriage pin frame.

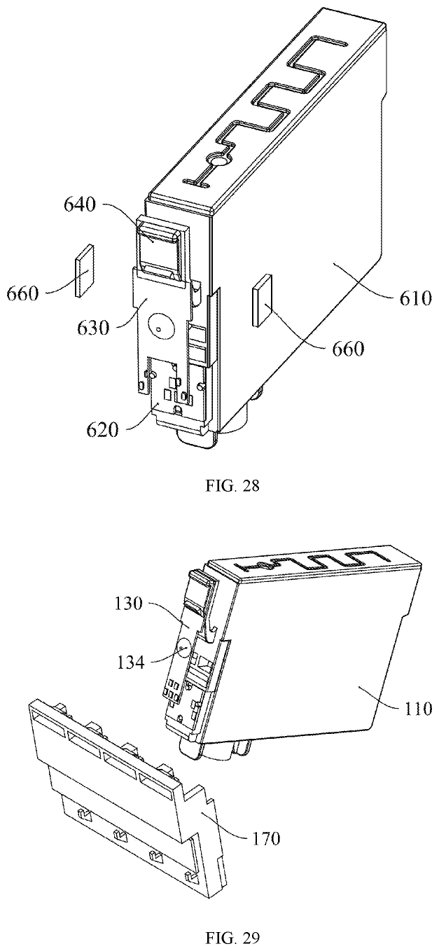

Referring to FIG. 28, to improve connection reliability between the second circuit board 630 and the box body 610, two fastening members 660 are disposed between the second circuit board 630 and the box body 610, the two fastening members 660 are respectively disposed on two sides of the second circuit board 630 in a width direction, and the upper end of the second circuit board 630 is fastened to the box body 610 by using the fastening members 660. Preferably, the second circuit board 630 is bonded to the fastening members 660 by using an adhesive, or is fastened to the fastening members 660 by using a screw. Likewise, the fastening member 660 may also be fastened to the box body 610 in an adhesive manner or a screw connection manner, or the fastening member 660 itself is a part of the box body 610, and they are integrally formed. By fastening the second circuit board 630 to the fastening member 660 rather than to the handle 612, deformation of the second circuit board 630 caused by pressing the handle for multiple times can be avoided.

### Seventh Embodiment

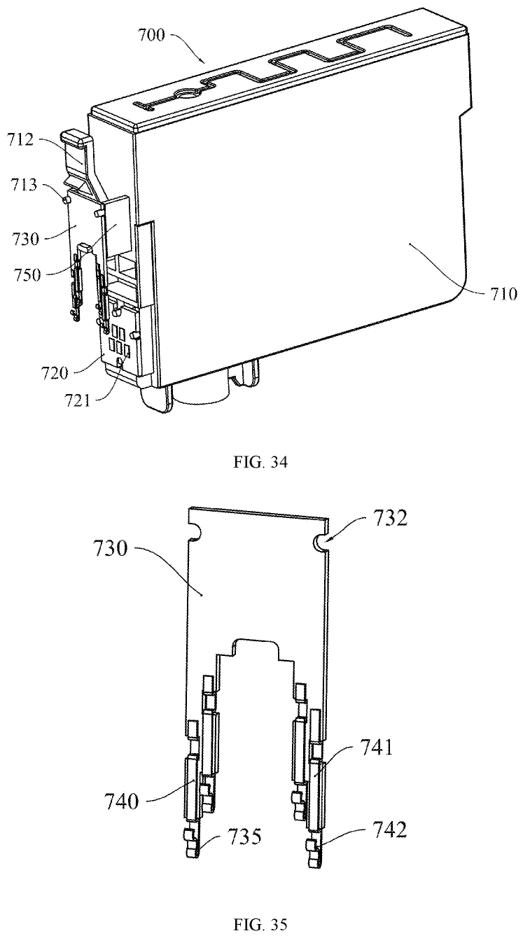

Referring to FIG. 34, an ink cartridge 700 in this embodiment has a box body 710, and the box body 710 encloses to form a cavity that accommodates ink. A handle 712 is disposed at an upper end of the box body 710, a first circuit board 720 is detachably installed on an outer wall of a lower end of the box body 710, five first function contact parts 721 are disposed on the first circuit board 720, and the five first function contact parts 721 are arranged in two first straight lines. A memory is disposed on the first circuit board 720, and the five first function contact parts 721 are electrically connected to the memory. In addition, the five first function contact parts 721 are electrically connected to pins on a first side of a printhead carriage pin frame.

A boss 750 and a second circuit board 730 are further disposed on the ink cartridge 700. The boss 750 extends outwardly from an outer wall of the upper end of the box body 710 by a specific height. A cross-section of the boss 750 is U-shaped, and surrounds a part of the handle 712 connected to the box body 710. The second circuit board 730 may be fastened to the boss 750. For example, as shown in FIG. 35, two limit slots 732 are disposed at an upper end of the second circuit board 730, and two corresponding protrusion posts 713 are disposed on the boss 750. The second circuit board 730 is fastened to the boss 750 through cooperation between the protrusion posts 713 and the limit slots 732.

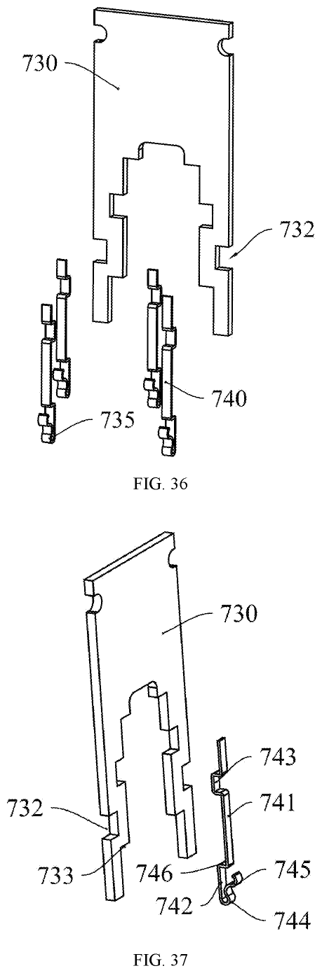

Four spring plates 740 are disposed on the second circuit board 730. Referring to FIG. 36 and FIG. 37, the spring plate 740 includes a first portion 741 and a second portion 742, and the first portion 741 is fastened to the second circuit board 730. Specifically, the first portion 741 is fastened to the second circuit board 730 in a patch manner, an elastic snap-fit part 743 is disposed in the first portion 741, a clamping slot 732 is disposed in the second circuit board 730, and the elastic snap-fit part 743 is snap-fit to the clamping slot 732, so as to implement positioning of the spring plate 740.

The second portion 742 of the spring plate 740 is in a bent shape and overhangs below the second circuit board 730. In this way, when the ink cartridge 700 is installed in place, a pin on a second side of the printhead carriage pin frame abuts against a lower end 735 of the second portion 742 of the spring plate 740, and squeezes the second portion 742 of the spring plate 740 in a direction toward a contact point on a chip main control circuit board, so that the spring plate 740 and the contact point on the chip main control circuit board implement stable electrical connection. In this embodiment, there are four spring plates 740, the four spring plates 740 form four second function contact parts, and the four second function contact parts are arranged in two second straight lines. Along a height direction of the box body 710, the two second straight lines are above the two first straight lines. The four second function contact parts are electrically connected to four contact points on the chip main control circuit board. It should be noted that the lower end 735 of the second portion 742 of the spring plate 740 may be electrically conductive, or may be brushed with an insulating paint so that the spring plate 740 is not electrically conductive. This depends on whether the first circuit board 720 has a contact point function corresponding to the position.

The second portion 742 is in a bent shape, and a U-shaped structure 744 is disposed at the lower end of the second portion 742. A bent part 745 at a substantially right angle is further disposed at a free end of the second portion 742, and the bent part 745 is configured to be electrically connected to the contact point on the chip main control circuit board.

In addition, an end of the first portion 741, that is, a joint between the first portion 741 and the second portion 742, forms a bent part 746 that extends in a horizontal direction, the bent part 746 is attached to a lower end edge of the second circuit board 730, and the bent part 746 is flush with the lower end edge of the second circuit board 730. In this way, the end of the first portion 741 is in a bent shape, so that the spring plate 740 has a larger elastic deformation space.

In this embodiment, the spring plate 740 is disposed in a bent shape, and a deformable length of the spring plate 740 is increased, so that the spring plate 740 generates proper elastic stress, and the bent part 745 is better electrically connected to the contact point on the chip main control circuit board. In addition, the spring plate 740 is fastened to the second circuit board 730 in a patch manner, and is then inserted between a rear row of pins of the printhead carriage pin frame and the chip main control circuit board. In this way, a length of the spring plate 740 can be reduced, a deformation possibility can be reduced, and strength of the spring plate 740 can be increased.

### Eighth Embodiment

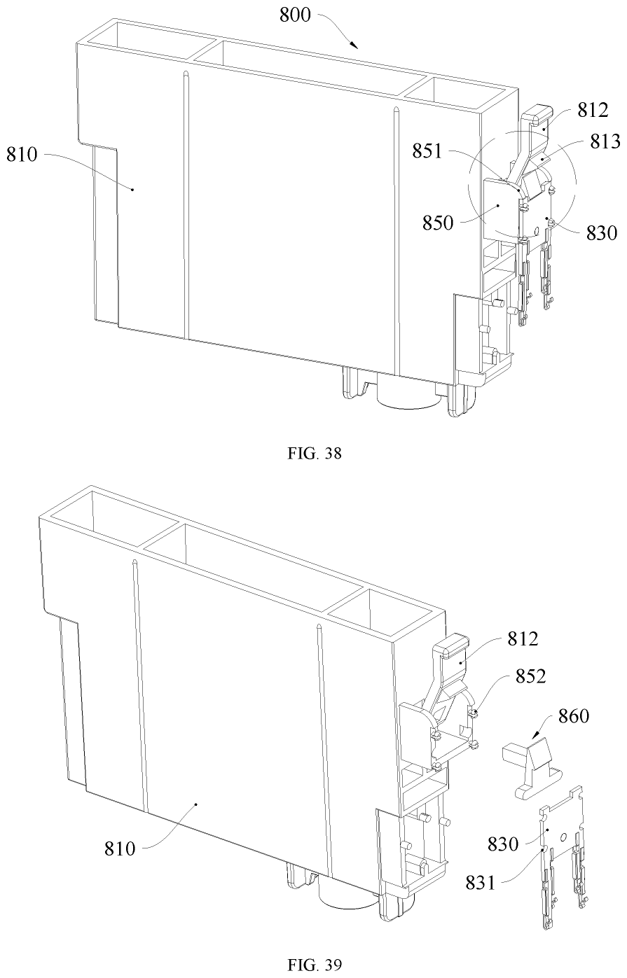

Referring to FIG. 38, an ink cartridge 800 in this embodiment has a box body 810, and the box body 810 encloses to form a cavity that accommodates ink. A handle 812 is disposed at an upper end of the box body 810, and a first circuit board is detachably installed on an outer wall of a lower end of the box body 810.

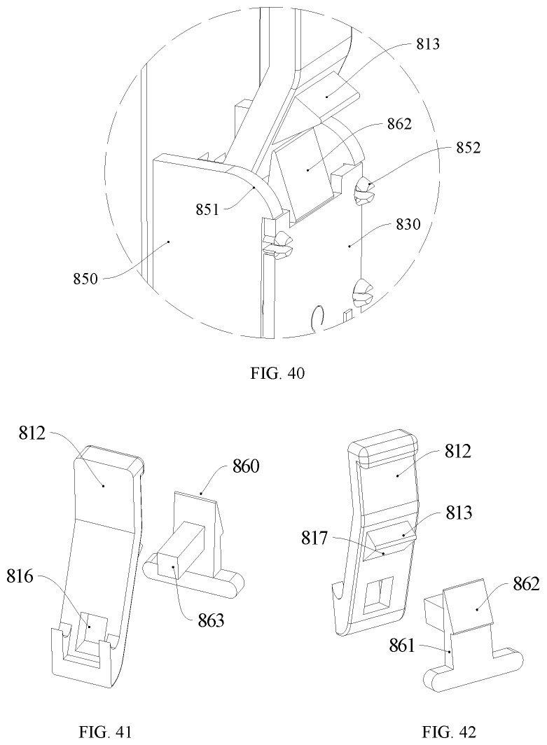

A boss 850 and a second circuit board 830 are further disposed on the ink cartridge 800. The boss 850 extends outwardly from an outer wall of the upper end of the box body 810 by a specific height. A cross-section of the boss 850 is U-shaped, and surrounds a part of the handle 812 connected to the box body 810. The second circuit board 830 may be fastened to the boss 850. As shown in FIG. 39 and FIG. 40, four limit slots 831 are disposed at an upper end of the second circuit board 830, and four corresponding protrusion posts 852 are disposed on the boss 850. The second circuit board 830 is fastened to the boss 850 through cooperation between the protrusion posts 852 and the limit slots 831. Different from the seventh embodiment, the protrusion post 852 in this embodiment includes two elastic clasps. There is a gap between the two elastic clasps, and the elastic clasps can more firmly limit the second circuit board 830.

A guide block 860 is disposed on the box body 810. Referring to FIG. 41 and FIG. 42, the guide block 860 has a body part 861, a fastening block 863 is disposed on a back side of the body part 861, and one end of the fastening block 863 is fastened to a side wall of the box body 810. In addition, a through hole 816 is disposed in the middle of the handle 812, and the fastening block 863 may pass through the through hole 816. An inclined guide surface 862 is disposed at an upper end of the body part 861. Referring to FIG. 40, when the second circuit board 830 is fastened to the handle 812, the guide surface 862 is disposed on an upper edge of the second circuit board 830.

A bump 813 is disposed on the handle 812, and a lower surface 817 of the bump 813 is also inclined. Preferably, an upper edge of the guide surface 862 is located below the bump 813. When the ink cartridge 800 is taken out of a printhead carriage, the guide surface 862 may cooperate with a protrusion of the printhead carriage, so as to avoid a problem that the ink cartridge 800 is difficult to take out because the protrusion of the printhead carriage is stuck on the upper edge of the second circuit board 830.

In addition, the boss 850 is disposed with a filleted corner 851 close to the handle 812. For some inkjet printers with a large projection of the printhead carriage, the filleted corner 851 may be designed to cooperate with the projection of the printhead carriage, so that the ink cartridge 800 is smoothly removed from the printhead carriage, and the projection of the printhead carriage is prevented from being stuck on the upper edge of the second circuit board 830.

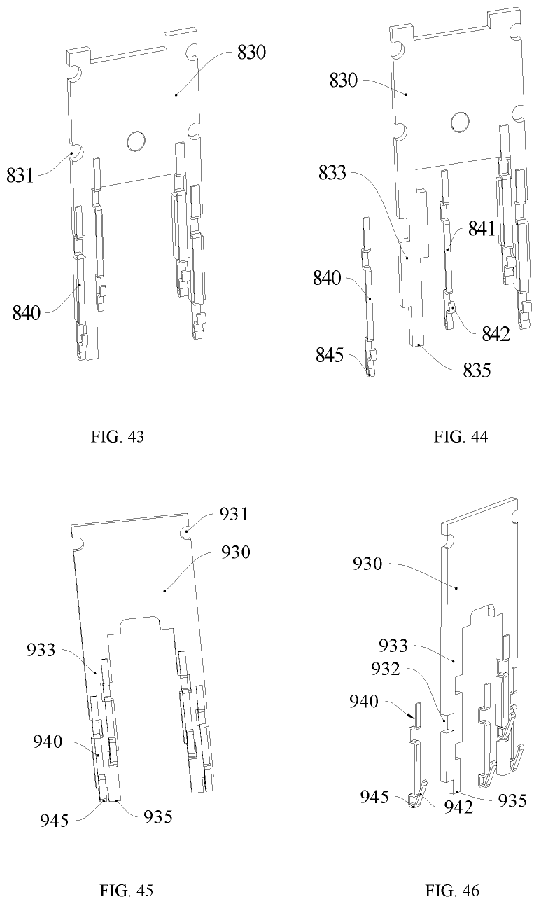

Referring to FIG. 43 and FIG. 44, four spring plates 840 are disposed on the second circuit board 830, and a shape of the spring plate 840 is the same as that in the seventh embodiment. The spring plate 840 has a first portion 841 and a second portion 842, and the second portion 842 is in a bent shape. A pin on a second side of a printhead carriage pin frame abuts against a lower end 845 of the second portion 842, and squeezes the second portion 842 of the spring plate 840 in a direction toward a contact point on a chip main control circuit board, so that the spring plate 840 and the contact point on the chip main control circuit board implement stable electrical connection.

Different from the seventh embodiment, in this embodiment, a lower end 835 of an extension post 833 of the second circuit board 830 is flush with the lower end 845 of the spring plate 840, that is, when the second circuit board 830 is placed in a vertical direction, the lower end 835 of the extension post 833 of the second circuit board 830 and the lower end 845 of the spring plate 840 are on a same horizontal line. In this way, the spring plate 840 can be prevented from being deformed due to excessive stress, and a service life of the second circuit board 830 can be prolonged. In addition, compared with the seventh embodiment, the spring plate 840 in this embodiment has a narrower width, that is, two spring plates 840 are located on two sides of one extension post 833.

### Ninth Embodiment

An ink cartridge in this embodiment has a box body, and the box body encloses to form a cavity that accommodates ink. A handle is disposed at an upper end of the box body, and a first circuit board is detachably installed on an outer wall of a lower end of the box body. A boss and a second circuit board are further disposed on the ink cartridge. Different from the eighth embodiment, this embodiment improves the second circuit board and a spring plate.

Referring to FIG. 45 and FIG. 46, two limit slots 931 are disposed on the second circuit board 930, and the circuit board 930 includes two extension posts 933. One spring plate 940 is disposed on both sides of each extension post 933, and a limit slot 932 is disposed on the extension post 933. The spring plate 940 may be matched with the limit slot 932 and fastened to the second circuit board 930.

In addition, a lower end 945 of the spring plate 940 is flush with a lower end 935 of the extension post 933, that is, when the second circuit board 930 is placed in a vertical direction, the lower end 935 of the extension post 933 of the second circuit board 930 and the lower end 945 of the spring plate 940 are on a same horizontal line. In addition, compared with the eighth embodiment, a length of a bent spring plate 940 in this embodiment decreases, and a second portion 942 of a folded spring plate 940 is shorter.

### Tenth Embodiment

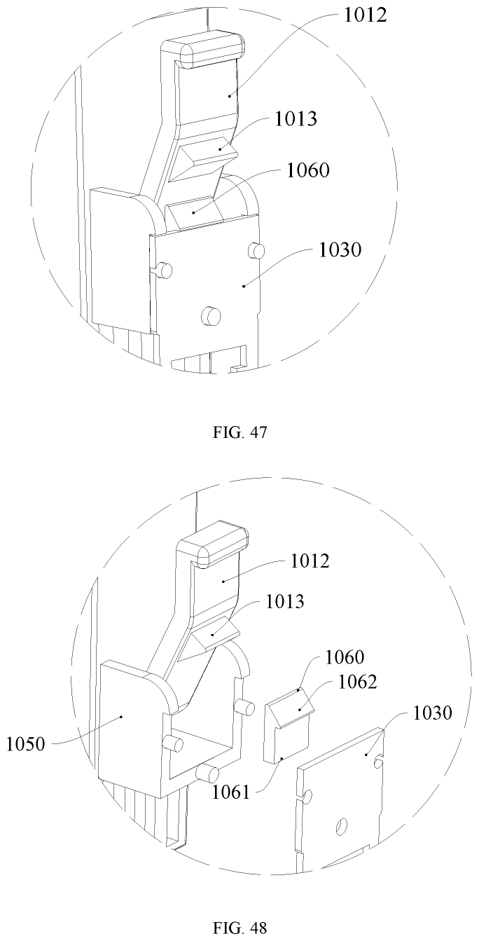

An ink cartridge in this embodiment has a box body, and the box body encloses to form a cavity that accommodates ink. Referring to FIG. 47 and FIG. 48, a handle 1012 is disposed at an upper end of the box body. Different from the eighth embodiment, a guide block 1060 in this embodiment is fastened to an upper end of a second circuit board 1030. Specifically, the guide block 1060 is not fastened to the box body, and the guide block 1060 has a body part 1061. An inclined guide surface 1062 is disposed at an upper end of the body part 1061. After the second circuit board 1030 is fastened to a boss 1050, the guide surface 1062 is disposed on an upper edge of the second circuit board 1030. The body part 1061 of the guide block 1060 is attached to a surface of the second circuit board 1030 close to the box body, for example, fastened in a manner of bonding or welding. Preferably, the guide block 1060 may be made of metal, plastic, or the like.

A bump 1013 is disposed on the handle 1012, and an upper edge of the guide surface 1062 is located below the bump 1013. When the ink cartridge is taken out of a printhead carriage, the guide surface 1062 may cooperate with a protrusion of the printhead carriage, so as to avoid a problem that the ink cartridge is difficult to take out because the protrusion of the printhead carriage is stuck on the upper edge of the second circuit board 1030.

In this embodiment, the guide block 1060 may be welded to the surface of the second circuit board 1030 close to the box body. In this way, a center of gravity of the second circuit board 1030 may fall on a side close to the boss, so as to prevent the second circuit board 1030 from being relatively heavy on a side far away from the boss but relatively light on a side close to the boss, thereby facilitating installation of the ink cartridge.

### Eleventh Embodiment

An ink cartridge in this embodiment has a box body, and the box body encloses to form a cavity that accommodates ink. A handle is disposed at an upper end of the box body, and a first circuit board is detachably installed on an outer wall of a lower end of the box body. A boss and a second circuit board are further disposed on the ink cartridge. Different from the eighth embodiment, this embodiment improves the second circuit board.

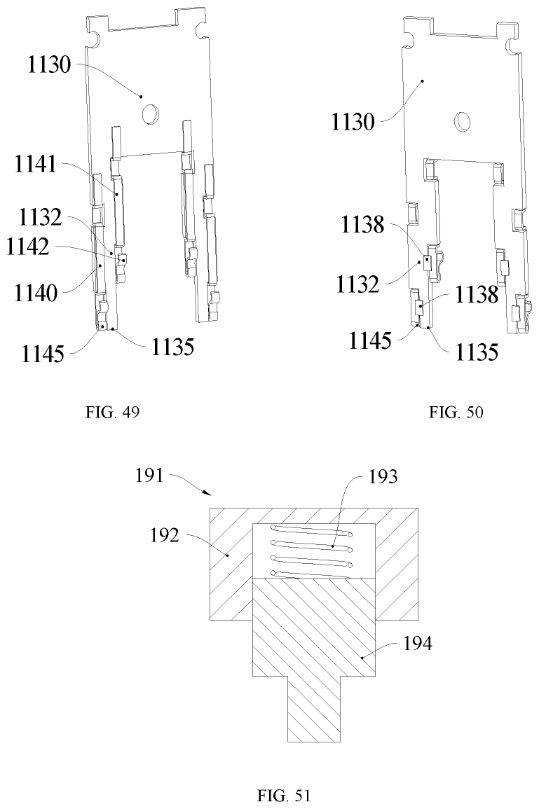

Referring to FIG. 49, the second circuit board 1130 has two extension posts 1132, and four spring plates 1140 are installed on the second circuit board 1130. A lower end of each spring plate 1140 is adjacent to the second circuit board 1130. Each spring plate 1140 has a first portion 1141 and a second portion 1142, and the second portion 1142 is in a bent shape. A pin on a second side of a printhead carriage pin frame abuts against a lower end 1145 of the second portion 1142, and squeezes the second portion 1142 of the spring plate 1140 in a direction toward a contact point on a chip main control circuit board, so that the spring plate 1140 and the contact point on the chip main control circuit board implement stable electrical connection.

In addition, a lower end 1135 of an extension post 1132 of the second circuit board 1130 is flush with the lower end 1145 of the spring plate 1140, that is, when the second circuit board 1130 is placed in a vertical direction, the lower end 1135 of the extension post 1132 of the second circuit board 1130 and the lower end 1145 of the spring plate 1140 are on a same horizontal line. In this way, the spring plate 1140 can be prevented from being deformed due to excessive stress, and a service life of the second circuit board 1130 can be prolonged. In addition, the spring plate 1140 in this embodiment has a narrower width, that is, two spring plates 1140 are located on two sides of one extension post 1132.

To better fasten the spring plate 1140 to the second circuit board 1130, referring to FIG. 50, in this embodiment, four pads 1138 are disposed on a surface of the second circuit board 1130 close to the box body, and each pad 1138 is welded to the extension post 1132 and the spring plate 1140, that is, the spring plate 1140 is fastened to the extension post 1132 by using the pad 1138. Preferably, the pad 1138 is disposed at a position close to a lower end of the spring plate 1140. In this way, shaking of the spring plate 1140 can be avoided, so that the spring plate 1140 is better fastened to the second circuit board 1130. In a process of installing or removing the ink cartridge, the spring plate 1140 can be attached to both sides of the extension post 1132, and damage to the spring plate 1140 can be avoided.

In the present invention, a case in which ink drops cause damage to a memory can be avoided, installation of a second circuit board is very convenient, and a problem that an inkjet printer is easily damaged due to installation of a connector independent of an ink cartridge can be avoided.

Finally, it should be emphasized that the present invention is not limited to the foregoing implementations. For example, specific shapes of multiple function contact parts on the first circuit board and the second circuit board are changed, a material used for the second circuit board is changed, or positions of the multiple function contact parts on the first circuit board and the second circuit board are interchanged. These changes should also fall within the protection scope of the claims of the present invention.

The foregoing describes merely specific implementations of this application, but the protection scope of this application is not limited thereto. The foregoing content describes merely implementations used for ease of understanding the present invention, and are not intended to limit the present invention. Any person skilled in the art, without departing from the technical scope disclosed in the present invention, may make any modification or change in implementation forms and details, which shall fall within the protection scope of this application. Therefore, the protection scope of this application shall be subject to the scope defined in the claims.

### INDUSTRIAL PRACTICALITY

A consumable container in the present invention is detachably installed in an inkjet printer. By using two mutually separated circuit boards, a case in which multiple function contact parts are short-circuited and a memory is damaged due to a foreign matter such as ink can be avoided, and installation of the consumable container can be further facilitated.

What is claimed is:

1. A consumable container, comprising:
a box body, wherein a first circuit board is disposed on a sidewall of the box body, at least one first function contact part is disposed on the first circuit board, and the first function contact part is configured to contact a pin on a first side of a printhead carriage pin frame;
wherein:
a second circuit board is further disposed on the box body, the second circuit board and the first circuit board are separated from each other, at least one second function contact part is disposed on the second circuit board, and the second function contact part is configured to contact a pin on a second side of the printhead carriage pin frame and/or a contact point on a chip main control circuit board.

2. The consumable container according to claim 1, wherein:
there are at least two first function contact parts, and multiple first function contact parts are arranged into one first straight line or two first straight lines;
there are at least two second function contact parts, and multiple second function contact parts are arranged into one second straight line or two second straight lines; and
along a height direction of the box body, the first straight line is located above the second straight line, or the first straight line is located below the second straight line.

3. The consumable container according to claim 1, wherein:
a memory is disposed on the first circuit board, and the first function contact part is electrically connected to the memory; or
a memory is disposed on the second circuit board, and the second function contact part is electrically connected to the memory.

4. The consumable container according to claim 1, wherein:
the second function contact part comprises a retractable conductive spring pin, a conductive sponge, or a conductive rubber.

5. The consumable container according to claim 1, wherein:
the second function contact part abuts against an upper end of the pin on the second side of the printhead carriage pin frame.

6. The consumable container according to claim 5, wherein:
a bevel is disposed at the upper end of the pin on the second side of the printhead carriage pin frame, and the second function contact part abuts against the bevel.

7. The consumable container according to claim 1, wherein:
a push block is further disposed on the second circuit board, and the push block guides a lower end of the second circuit board to avoid an upper surface of the chip main control circuit board when the consumable container is installed.

8. The consumable container according to claim 1, wherein:
at least one spring plate is disposed on the second circuit board, a first portion of the spring plate is fastened to the second circuit board, a second portion of the spring plate is in a bent shape and overhangs the second circuit board, and the second function contact part is disposed in the second portion.

9. The consumable container according to claim 8, wherein:
the first portion is fastened to the second circuit board in a patch manner.

10. The consumable container according to claim 9, wherein:
an elastic snap-fit part is disposed in the first portion, a clamping slot is disposed in the second circuit board, and the elastic snap-fit part is snap-fit to the clamping slot.

11. The consumable container according to claim 10, wherein:
an end of the first portion is flush with a lower end edge of the second circuit board, and forms a bent shape.

12. The consumable container according to claim 1, wherein:
a guide block is disposed on the box body, the guide block has an inclined guide surface, and the inclined guide surface is disposed on an upper edge of the second circuit board.

13. The consumable container according to claim 12, wherein:
a handle is disposed on the sidewall of the box body, and a through hole is disposed on the handle; and
the guide block has a body part, a fastening block is disposed on the body part, and the fastening block passes through the through hole and is fastened on the sidewall of the box body.

14. The consumable container according to claim 13, wherein:
the inclined guide surface is disposed at an upper end of the body part.

15. The consumable container according to claim 13, wherein:
a boss is disposed on the sidewall of the box body, the second circuit board is fastened on the boss, and the boss is disposed with a filleted corner close to the handle.

16. The consumable container according to claim 12, wherein:
the guide block has a body part, and the body part of the guide block is attached to a surface of the second circuit board close to the box body.

17. The consumable container according to claim 8, wherein:
the spring plate is adjacent to the second circuit board, and a pad is welded to the second circuit board and the spring plate.

18. The consumable container according to claim 17, wherein:
the pad is disposed on a surface of the second circuit board close to the box body.

19. A separable consumable chip, comprising:
a first circuit board, wherein at least one first function contact part is disposed on the first circuit board, and the first function contact part is configured to contact a pin on a first side of a printhead carriage pin frame; and
a second circuit board, wherein the second circuit board and the first circuit board are separated from each other, at least one second function contact part is disposed on the second circuit board, and the second function contact part is configured to contact a pin on a second side of the printhead carriage pin frame and/or a contact point on a chip main control circuit board.

20. An inkjet printer, comprising a printer body, wherein a chip main control circuit board and a printhead carriage are disposed in the printer body, a printhead carriage pin frame is disposed on the printhead carriage, and a pin is disposed on each of both sides of the printhead carriage pin frame; wherein
one or more consumable containers according to claim 1 and/or one or more separable consumable chips are installed in the inkjet printer, and a lower end of the second circuit board is inserted between the chip main control circuit board and a pin on a second side of the printhead carriage pin frame;
wherein each of the one or more separable consumable chips comprises:
a first circuit board, wherein at least one first function contact part is disposed on the first circuit board, and the first function contact part is configured to contact a pin on a first side of the printhead carriage pin frame; and
the second circuit board, wherein the second circuit board and the first circuit board are separated from each other, at least one second function contact part is disposed on the second circuit board, and the second function contact part is configured to contact the pin on the second side of the printhead carriage pin frame and/or a contact point on the chip main control circuit board.
